(19) United States
(12) Patent Application Publication
(10) Pub. No.: US 2023/0107200 A1
(43) Pub. Date: Apr. 6, 2023

(54) PROGRAM GENERATION APPARATUS, PROGRAM GENERATION METHOD AND PROGRAM

(71) Applicant: NIPPON TELEGRAPH AND TELEPHONE CORPORATION, Tokyo (JP)

(72) Inventors: Toshiyuki KURABAYASHI, Tokyo (JP); Hiroyuki KIRINUKI, Tokyo (JP); Yu YOSHIMURA, Tokyo (JP)

(73) Assignee: NIPPON TELEGRAPH AND TELEPHONE CORPORATION, Tokyo (JP)

(21) Appl. No.: 17/798,880

(22) PCT Filed: Feb. 12, 2020
(86) PCT No.: PCT/JP2020/005385

§ 371 Date: Aug. 10, 2022

(51) Int. Cl. G06F 8/30

(52) U.S. Cl. CPC G06F 8/30

(57) ABSTRACT

The possibility of a desired program being automatically generated is increased by a program generation device including: a generation unit configured to generate, by using a plurality of program components, a program that takes a value and a unit of the value as input and outputs a calculation result of the value and a calculation result of the unit by executing a calculation relating to the value and a calculation relating to the unit, which corresponds to the calculation relating to the value; and a change unit configured to change the program to generate a program that satisfies at least one pair of an input value having a unit and an output value having a unit.

### TECHNICAL FIELD

The present invention relates to a program generation device, a program generation method, and a program.

### BACKGROUND ART

In recent years, application of IT is increasing throughout the society and insufficiency of IT human resources is a big issue. According to a calculation made by the Ministry of Economy, Trade and Industry, it is estimated that there will be a lack of about 360,000 IT human resources in 2025. In particular, the shortage of IT human resources in implementation processes for which expertise is required is an urgent issue, and there are demands for research and development of automatic programing technologies for automatically carrying out programing.

As a conventional automatic programing technology, there is a technology for compositing components of a program so as to satisfy input-output examples of the program that are given by a user.

For example, NPL 1 discloses a technology for realizing efficient program synthesis by learning a relationship between input-output examples and program components, estimating a program component that has a high probability of being used for a given input-output example, and using the component for synthesis of a program.

Also, NPL 2 discloses a technology for automatically synthesizing an Excel (registered trademark) function from input-output examples of Excel (registered trademark) so as to satisfy the input-output examples.

### CITATION LIST

### Non Patent Literature

[NPL 1] Matej Balog, Alexander L. Gaunt, Marc Brockschmidt, Sebastian Nowozin, Daniel Tarlow, “DeepCoder: Learning to Write Programs” Proceedings of ICLR′17, [online], Internet <URL:https://www.microsoft.com/en-us/research/publication/deep coder-learning-write-programs/>

[NPL 2] Sumit Gulwani, “Automating String Processing in Spreadsheets Using Input-Output Examples” POPL '11 Proceedings of the 38th annual ACM SIGPLAN-SIGACT symposium on Principles of programming languages Pages 317-330, [online], Internet <URL:https://dl.acm.org/citation.cfm?id=1926423>

### SUMMARY OF THE INVENTION

### Technical Problem

However, input-output examples are merely examples of a specification satisfied by the program, and there is a shortcoming in that the amount of information is small. Therefore, there is a problem in that there are cases where a program that is overfitted to the input-output examples is generated and the program desired by the user is not generated.

The present invention was made in view of the foregoing, and has an object of increasing the possibility of the desired program being automatically generated.

### Means for Solving the Problem

In order to solve the problem described above, a program generation device includes: a generation unit configured to generate, by using a plurality of program components, a program that takes a value and a unit of the value as input and outputs a calculation result of the value and a calculation result of the unit by executing a calculation relating to the value and a calculation relating to the unit, which corresponds to the calculation relating to the value; and a change unit configured to change the program to generate a program that satisfies at least one pair of an input value having a unit and an output value having a unit.

### Effects of the Invention

The possibility of the desired program being automatically generated can be increased.

### BRIEF DESCRIPTION OF DRAWINGS

FIG. 1 is a diagram showing an example of a hardware configuration of a program generation device 10 in an embodiment of the present invention.

FIG. 2 is a diagram showing an example of a functional configuration of the program generation device 10 in an embodiment of the present invention.

FIG. 3 is a flowchart showing an example of a processing procedure executed by the program generation device 10.

FIG. 4 is a diagram showing an example of a program component list.

FIG. 5 is a diagram showing an example of an input-output example set.

FIG. 6 is a diagram showing an example of synthesized codes that are generated through synthesized code change processing.

FIG. 7 is a diagram showing an example of removing a description of a calculation of unit from a synthesized code.

### DESCRIPTION OF EMBODIMENTS

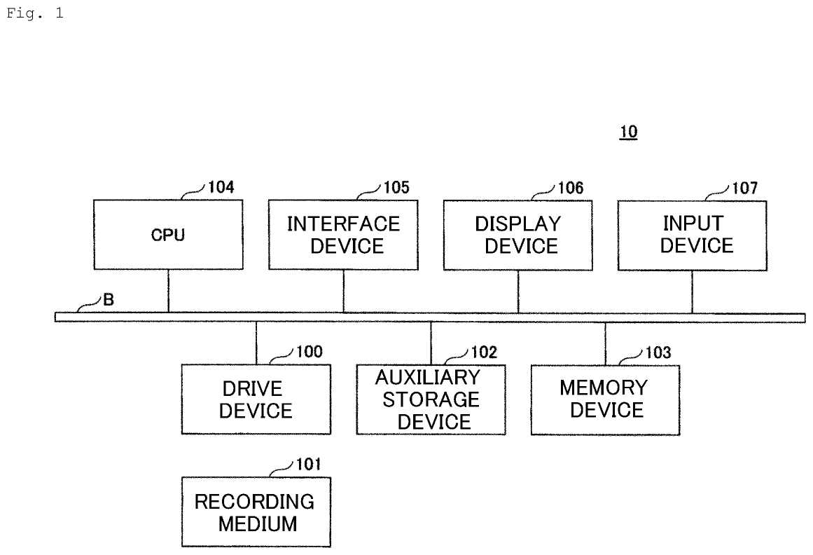

The following describes an embodiment of the present invention based on the drawings. FIG. 1 is a diagram showing an example of a hardware configuration of a program generation device 10 in the embodiment of the present invention. The program generation device 10 shown in FIG. 1 includes a drive device 100, an auxiliary storage device 102, a memory device 103, a CPU 104, an interface device 105, a display device 106, an input device 107, and the like, which are connected to each other via a bus B.

A program that realizes processing performed in the program generation device 10 is provided using a recording medium 101 such as a CD-ROM. When the recording medium 101 on which the program is stored is set in the drive device 100, the program is installed in the auxiliary storage device 102 from the recording medium 101 via the drive device 100. However, the program does not necessarily have to be installed from the recording medium 101, and may be downloaded from another computer via a network. The auxiliary storage device 102 stores therein the installed program and necessary files, data, and the like.

When a program start instruction is given, the memory device 103 reads the program from the auxiliary storage device 102 and stores the program in the memory device 103. The CPU 104 realizes functions relating to the program generation device 10 in accordance with the program stored in the memory device 103. The interface device 105 is used as an interface for connection to a network. The display device 106 displays GUI (Graphical User Interface) or the like of the program. The input device 107 is constituted by a keyboard and a mouse, for example, and is used to input various operation instructions.

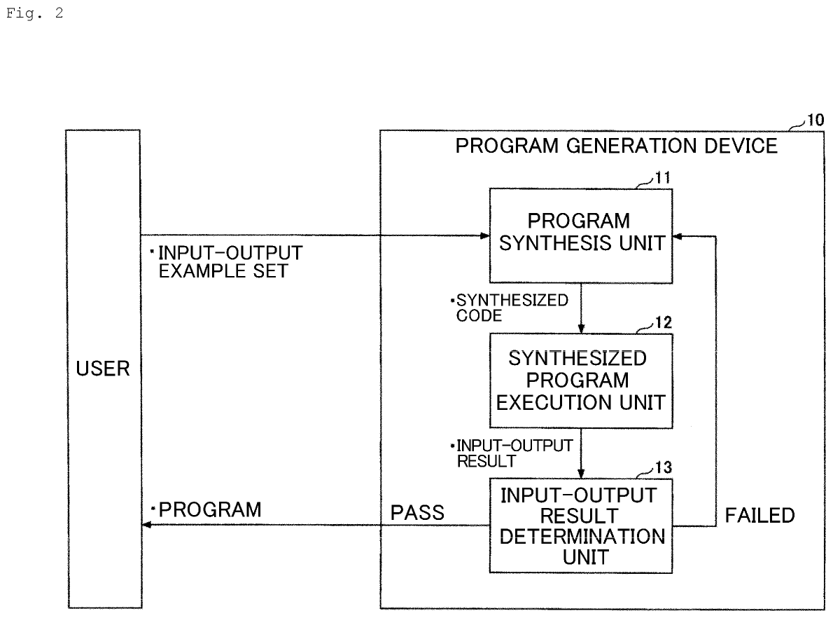

FIG. 2 is a diagram showing an example of a functional configuration of the program generation device 10 in the embodiment of the present invention. The program generation device 10 shown in FIG. 2 includes a program synthesis unit 11, a synthesized program execution unit 12, and an input-output result determination unit 13. These units are realized through processing that one or more programs installed in the program generation device 10 cause the CPU 104 to execute.

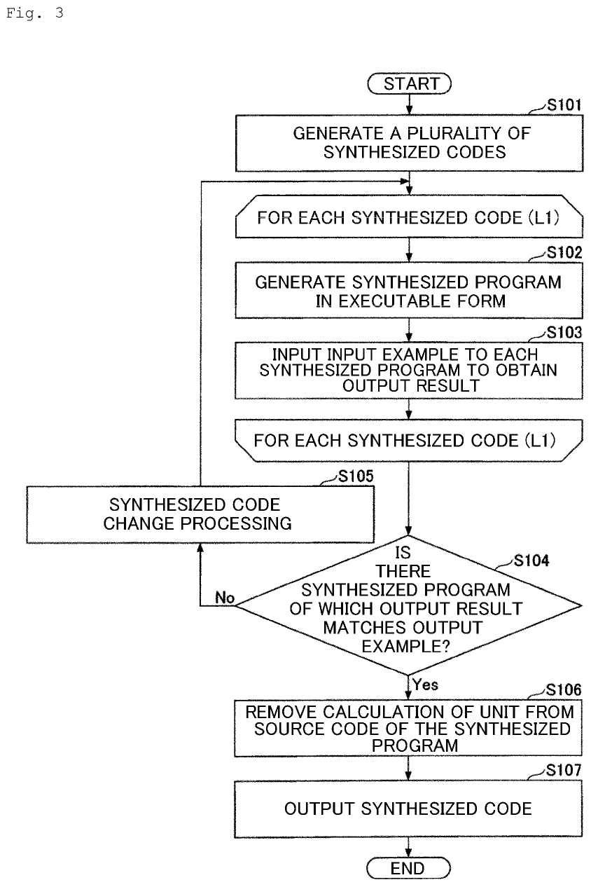

The following describes a processing procedure that is executed by the program generation device 10. FIG. 3 is a flowchart showing an example of the processing procedure executed by the program generation device 10.

In step S101, the program synthesis unit 11 generates source codes (hereinafter referred to as “synthesized codes”) of a plurality of (N) programs by, for example, randomly combining and compositing one or more program components included in a program component list that is stored in the auxiliary storage device 102, for example.

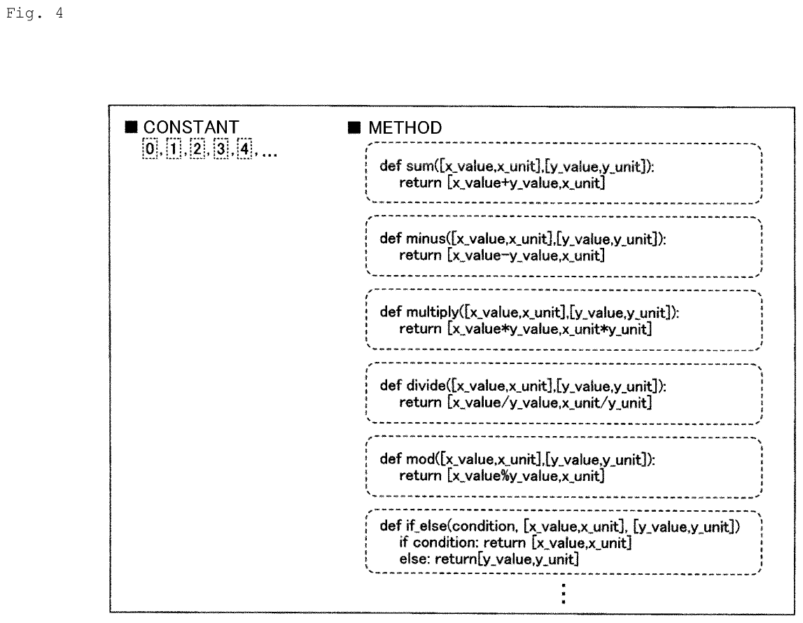

FIG. 4 is a diagram showing an example of the program component list. The following is the data structure of the program component list shown in FIG. 4, which is written in a form that is based on the BNF (Backus-Naur form) notation.

### <Program Component List>:=Program Component+

That is, the program component list includes one or more program components (source codes of the program components). In FIG. 4, the program components are categorized into constants and methods. Here, a single constant corresponds to a single program component, and a single method corresponds to a single program component. That is, each unit surrounded by a dashed line in FIG. 4 corresponds to a unit of a single program component.

The present embodiment is configured such that it is possible to input not only the value of each argument of each method but also the unit of the value. For example, arguments of the topmost method shown in FIG. 4 are [x_value,x_unit] and [y_value,y_unit]. Here, each region enclosed by [ ] indicates a single array. In the array, the first element is a value (numerical value) and the second element is a character string that indicates the unit of the value. That is, a single argument is constituted by a pair of a value and a unit. Specifically, x_value and y_value are values of the arguments that are to be calculated. On the other hand, x_unit is a character string that indicates the unit of the value x_value, and y_unit is a character string that indicates the unit of the value y_value.

Also, the definition of each method indicates a calculation method of the array. Specifically, in the calculation method of the array, the first element indicates a calculation method of the value and the second element indicates a calculation method of the unit that corresponds to the calculation method of the first element. That is, the definition of each method includes not only a calculation method regarding values (x_value, y_value) specified as arguments but also a calculation method regarding units (x_unit, y_unit) specified for the arguments, which corresponds to the calculation method regarding values. Accordingly, each program component is defined so as to perform a calculation relating to input units in connection with a calculation relating to input values, and output a calculation result of the values and a calculation result of the units.

The calculation method of units corresponding to the calculation of values essentially follows the following rule. However, if there is an exception, another rule may be separately set. The following rule shows calculation methods of units of values for cases where the values are added, subtracted, multiplied, or divided.

[Addition and Subtraction]
(1) When values having the same unit are added or subtracted, the unit is used as the unit of an addition result or a subtraction result.
Example: 1[m]+2[m]=3[m]
(2) When a source code includes addition or subtraction of variables that have different units, the source code is taken to be an inappropriate source code.

[Multiplication and Division]

Regardless of whether units are the same or different, the units are calculated in the same manner as values that are multiplied or divided.
Example: 1[m]*2[m]=2[m*m]
Example: 1[m]*2=2[m]
Example: 1[m]*2[g]=2[m*g]
Example: 1[m]/2[m]=½
In step S101, processing for generating a single synthesized code by selecting a plurality of program components at random and compositing the plurality of program components is repeated N times. As a result, N synthesized codes are generated. It should be noted that compositing program components means combining calculations of the plurality of program components, and can be performed using a known technology such as the technology described in NPL 1, for example. For example, each program component can be expressed using a tree structure in which an operator serves as a parent node and a variable, a constant, or an operator for which an operation is performed using the operator serves as a child node, and a node in the tree structure of a program component can be replaced with the tree structure of another program component to composite these program components. It should be noted that similarly to the program components, each synthesized code includes a definition of taking a pair of a value and a unit as input, executing a calculation relating to the input unit in connection with a calculation relating to the input value, and outputting a calculation result of the value and a calculation result of the unit.

Subsequently, loop processing L1 that includes steps S102 and S103 is executed for each synthesized code. In the following description, a synthesized code for which the loop processing L1 is performed will be referred to as a “target code”.

In step S102, the synthesized program execution unit 12 generates a program (hereinafter referred to as a “synthesized program”) in an executable form by performing compiling, linking, and the like on the target code.

Subsequently, the synthesized program execution unit 12 executes the synthesized program (hereinafter referred to as the “target synthesized program”) by inputting each input-output example included in an input-output example set that is prepared in advance, to the target synthesized program, and obtains output for each input-output example (step S103). The input-output example set is information that indicates conditions to be satisfied by the program to be generated (hereinafter referred to as the “target program”) with respect to input and output, and is set in advance and stored in the auxiliary storage device 102, for example.

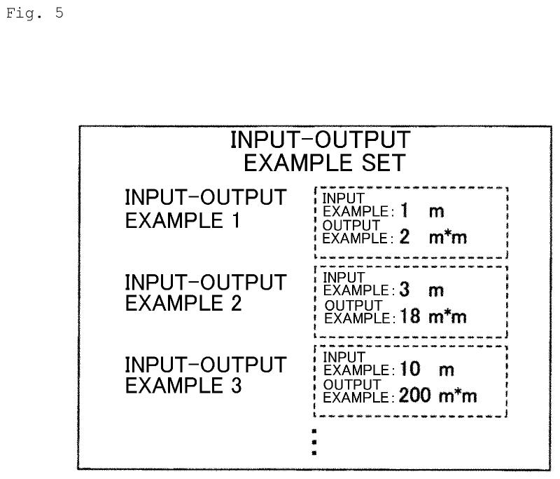

FIG. 5 is a diagram showing an example of the input-output example set. The following is the data structure of the input-output example set shown in FIG. 5, which is written in a form that is based on the BNF notation.
<input-output example set>::=<input-output example>+
<input-output example>::=<input example><output example>
<input example>::=<input value unit>+
<output example>::=<output value unit>+

That is, the input-output example set includes one or more input-output examples. Each input-output example is a pair of an input example and an output example. The input example is at least one pair of an input value (numerical value) and a unit of the input value, and the output example is at least one pair of an output value (numerical value) and a unit of the output value.

For example, in a case where the input-output example set includes M input-output examples, instep S103, the synthesized program execution unit 12 executes the target synthesized program for each of M input examples by inputting input values and units, and obtains M output values and units.

When the loop processing L1 has ended, the input-output result determination unit 13 determines whether there is a synthesized program for which all pairs of output values and units match output examples (pairs of output values and units) of input-output examples to which input values corresponding to the output values and units belong (step S104). That is, it is determined whether there is a synthesized program for which all output values and units obtained in step S103 were as expected (correct) , among synthesized programs for which the loop processing L1 has been performed.

If there is no synthesized program that satisfies the condition of step S104 (No in step S104), the program synthesis unit 11 executes synthesized code change processing (step S105). In the synthesized code change processing, a plurality of (N) synthesized codes are generated by partially changing the original synthesized code. For example, a genetic algorithm may be used to partially change the synthesized code. That is, a genetic operation may be performed N times on the synthesized code of the previous generation to generate N synthesized codes of the next generation. Here, N represents the number of individuals (source codes) of a single generation of the genetic algorithm. At this time, each synthesized code to which the genetic algorithm is applied is expressed using a tree structure in which an operator serves as a parent node and a variable, a constant, or an operator for which an operation is performed using the operator serves as a child node, for example, and the genetic operation is performed on a subtree of the tree structure. A pass rate of output (a rate at which the output (output values and units) was correct) may be used in evaluation for selecting individuals on which the genetic operation is performed N times.

For example, program components included in the program component list are used as candidates that replace a portion of the synthesized code of the previous generation in mutations.

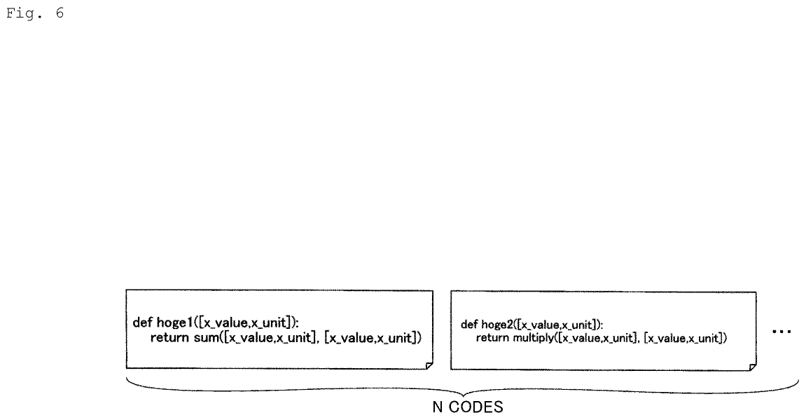

FIG. 6 is a diagram showing an example of synthesized codes that are generated through the synthesized code change processing. As shown in FIG. 6, N synthesized codes are generated as a result of synthesis processing being performed once.

It should be noted that an existing library such as DEAP (https://deap.readthedocs.io/en/master/) may be used for program synthesis processing in which the genetic algorithm is used.

Subsequently, the loop processing L1 and the following processing are executed for the N synthesized codes. Accordingly, in this case, steps S102 and S103 are executed N times.

On the other hand, if there is at least one synthesized program that satisfies the condition of step S104 (Yes in step S104) , the loop processing L1 ends and the procedure proceeds to step S106. That is, in the loop processing L1, the target program that satisfies the input-output example set is automatically generated as a result of a partial change of the synthesized code being repeated (the synthesized code being cumulatively changed portion by portion) until a program that satisfies the input-output examples generated in advance is generated.

In step S106, the input-output result determination unit 13 removes (deletes) a description of the calculation of unit from the source code (synthesized code) of the synthesized program. In a case where there are a plurality of synthesized programs that satisfy the condition of step S104, the processing in step S106 can be performed on source codes of the respective synthesized programs.

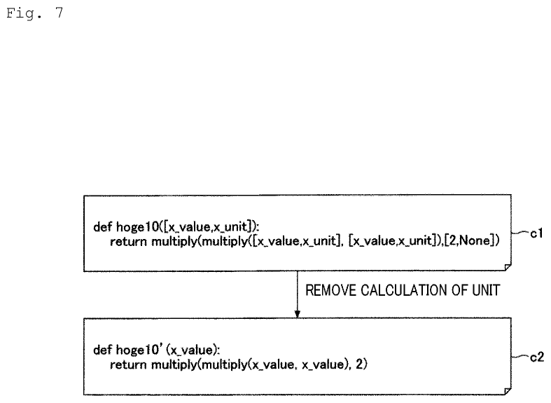

FIG. 7 is a diagram showing an example of removing a description of the calculation of unit from a synthesized code. In FIG. 7, a synthesized code c1 is an example of a synthesized code that satisfies the condition of step S104. A synthesized code c2 is an example of a synthesized code that is obtained by removing a description of the calculation of unit from the synthesized code c1. That is, in the synthesized code c2, a description relating to a variable (x_unit, y_unit) that corresponds to a unit in the synthesized code c1 has been removed.

Subsequently, the input-output result determination unit 13 outputs the synthesized code from which the description of the calculation of unit has been removed (step S107). That is, a synthesized program according to the synthesized code is determined to be the target program.

As described above, according to the present embodiment, in addition to a value, information of a unit is included in an input-output example, and a program (program relating to numerical calculation) that is expected to satisfy input and output in terms of both the value and the unit is automatically generated. That is, when calculation is performed by applying an input-output example to a program that is obtained by compositing program components and a program that is obtained by partially changing the aforementioned program, not only a numerical calculation but also a calculation of the unit is performed, and whether not only an output value but also the unit of the output value matches the unit in the output example given in advance is checked.

For example, assume that the desired program is a program for finding the area of a square. Assume that the user has given an input value 2 and an output value 4 as an input-output example. In this case, a program “x*x” has to be output, but a program “x+x” maybe output because this program also satisfies the input-output example. On the other hand, in the present embodiment, information of the unit is added as in “input value 2[m]” and “output value 4[m*m]”, and calculation is executed not only for the numerical value but also for the unit. Accordingly, it is possible to determine that the program “x+x” is inappropriate because the program outputs a value 4[m]. As a result, inappropriate programs can be excluded and the possibility of the desired program being automatically generated can be increased.

In the present embodiment, the program synthesis unit 11 is an example of a generation unit and a change unit.

Although an embodiment of the present invention has been described in detail, the present invention is not limited to the specific embodiment, and various alterations and changes can be made within the scope of the gist of the present invention described in the claims.

### REFERENCE SIGNS LIST

10 Program generation device
11 Program synthesis unit
12 Synthesized program execution unit
13 Input-output result determination unit
100 Drive device
101 Recording medium
102 Auxiliary storage device
103 Memory device
104 CPU
105 Interface device
106 Display device
107 Input device
B Bus

1. A program generation device comprising a processor configured to execute a method comprising:
generating, by using a plurality of program components, a program receiving a first combination including a first value and a first unit of the first value as input and outputting a second combination including a first calculation result of the first value and a second calculation result of the first unit by executing a first calculation associated with the first value and a second calculation associated with to the first unit, and the second calculation is based on the first calculation associated with the first value; and
changing the program, wherein the changed program satisfies at least one pair of a target input value having a target input unit and a target output value having a target output unit.

2. The program generation device according to claim 1, wherein
the changing repeats at least a partial change of the program in a cumulative manner until the program that satisfies the at least one pair of the target input value having the target input unit and the target output value having the target output unit is generated.

3. A computer implemented method for generating a program, comprising:
generating, using a plurality of program components, a program receiving a first combination including a first value and a first unit of the first value as input and outputting a second combination including a first calculation result of the first value and a second calculation result of the first unit by executing a first calculation associated with the first value and a second calculation associated with the first unit, and the second calculation is based on the first calculation associated with the first value; and
changing the program to generate a program that satisfies at least one pair of a target input value having a target input unit and a target output value having a target output unit.

4. The program generation method according to claim 3, wherein
the changing repeats at least a partial change of the program in a cumulative manner until the program that satisfies the at least one pair of the target input value having the target input unit and the target output value having the target output unit is generated.

5. A computer-readable non-transitory recording medium storing computer-executable program instructions that when executed by a processor cause a computer to execute a method comprising:
generating, using a plurality of program components, a program receiving a first combination including a first value and a first unit of the first value as input and outputting a second combination including a first calculation result of the first value and a second calculation result of the first unit by executing a first calculation associated with the first value and a second calculation associated with the first unit, and the second calculation is based on the first calculation associated with the first value; and
changing the program to generate a program that satisfies at least one pair of a target input value having a target input unit and a target output value having a target output unit.

6. The program generation device according to claim 1, wherein the constraint further includes the target output unit associated with a result of addition of values with a same unit includes indicates the same unit.

7. The program generation device according to claim 1, wherein the constraint further includes the target output unit associated with a result of multiplication of values with a same unit includes indicates a multiplication between the same unit.

8. The program generation device according to claim 1, wherein the program is based on synthesizing a combination of program components stored in a storage.

9. The program generation device according to claim 1, wherein the changing the program further comprises modifying a code associated with the program based on generating a modified code using a genetic algorithm.

10. The program generation device according to claim 1, wherein the changing the program further comprises replacing at least a part of the code associated with the program with a program component stored in a storage according to a mutation of a genetic algorithm.

11. The computer implemented method according to claim 3, wherein the constraint further includes the target output unit associated with a result of addition of values with a same unit includes indicates the same unit.

12. The computer implemented method according to claim 3, wherein the constraint further includes the target output unit associated with a result of multiplication of values with a same unit includes indicates a multiplication between the same unit.

13. The computer implemented method according to claim 3, wherein the program is based on synthesizing a combination of program components stored in a storage.

14. The computer implemented method according to claim 3, wherein the changing the program further comprises modifying a code associated with the program based on generating a modified code using a genetic algorithm.

15. The program generation device according to claim 1, wherein the changing the program further comprises replacing at least a part of the code associated with the program with a program component stored in a storage according to a mutation of a genetic algorithm.

16. The computer-readable non-transitory recording medium according to claim 5, wherein
the changing repeats at least a partial change of the program in a cumulative manner until the program that satisfies the at least one pair of the target input value having the target input unit and the target output value having the target output unit is generated.

17. The computer-readable non-transitory recording medium according to claim 5, wherein the constraint further includes the target output unit associated with a result of addition of values with a same unit includes indicates the same unit, and
wherein the constraint further includes the target output unit associated with a result of multiplication of values with a same unit includes indicates a multiplication between the same unit.

18. The computer-readable non-transitory recording medium according to claim 5, wherein the program is based on synthesizing a combination of program components stored in a storage.

19. The computer-readable non-transitory recording medium according to claim 5, wherein the changing the program further comprises modifying a code associated with the program based on generating a modified code using a genetic algorithm.

20. The computer-readable non-transitory recording medium according to claim 5, wherein the changing the program further comprises replacing at least a part of the code associated with the program with a program component stored in a storage according to a mutation of a genetic algorithm.
